(19) United States
(12) Patent Application Publication
(10) Pub. No.: US 2022/0179775 A1
(43) Pub. Date: Jun. 9, 2022

(54) BROWSERLESS TESTING

(71) Applicant: PayPal, Inc., San Jose, CA (US)

(72) Inventors: Krupa Sriram, Erod (IN); Somu Arunachalam, Chennai (IN); Aswanth Kumar Latchipatruni, Bobbili (IN); Veera Saka, Andhra Pradesh (IN); Prabu Periasamy, Chennai (IN); Nandhakumar Palanisamy, Bangalore (IN)

(21) Appl. No.: 17/113,256

(22) Filed: Dec. 7, 2020

(51) Int. Cl. G06F 11/36; H04L 29/08; G06F 16/958

(52) U.S. Cl. CPC G06F 11/3664; H04L 67/02; G06F 11/3612; G06F 16/958; H04L 67/146

(57) ABSTRACT

Systems and/or techniques for facilitating browserless testing of web servers are provided. In various embodiments, a system can record a hypertext transfer protocol (HTTP) request message. In various cases, the HTTP request message can be generated by a client device and can be transmitted from the client device to a deployed web server. In various aspects, the system can record a first HTTP response message. In various cases, the first HTTP response message can be generated by the deployed web server based on the HTTP request message, and can be transmitted from the deployed web server to the client device. In various instances, the system can browserlessly transmit the HTTP request message to a web server undergoing testing. In various cases, the web server undergoing testing can generate a second HTTP response message based on the HTTP request message. In various aspects, the system can browserlessly receive the second HTTP response message from the web server undergoing testing. In various instances, the system can compare a first message body of the first HTTP response message to a second message body of the second HTTP response message, without rendering the first HTTP response message and without rendering the second HTTP response message.

### TECHNICAL FIELD

The subject disclosure relates generally to testing of web servers, and more specifically to browserless testing of web servers.

### BACKGROUND

Conventionally, testing of a web server is browser-specific. Such conventional testing involves creating a testing program that is configured to instruct a browser to send requests to the web server and to instruct the browser to receive responses from the web server. Once the browser receives the responses from the web server, the browser renders the responses on a computer screen, and the testing program evaluates the rendered responses to determine whether the web server is functioning as desired. However, the testing program does not, by itself, cause the browser to perform such actions. This is because the browser has a user interface that is configured to receive input from a human operator such as via mouse clicks; the browser is not configured to receive instructions from the testing program. Thus, in order for a conventional testing program to interact with the browser, the testing program needs to be coupled with a browser driver that is specifically configured to interact with the user interface of the browser. Unfortunately, there are many different existing browsers (e.g., Chrome, Safari, Firefox, Internet Explorer, Opera, Microsoft Edge, Chromium, and so on), and each browser is configured differently. This means that a different browser driver is needed for each different browser that is tested. Downloading such different browser drivers and/or resolving version/compatibility mismatches between browsers and browser drivers can be very time-consuming and inefficient. In other words, conventional testing of a web server utilizes browsers and browser drivers, and thus such conventional testing spends excessive amounts of time and effort on setting up of the testing environment.

Systems and/or techniques that can ameliorate one or more of these technical issues are desirable.

### BRIEF DESCRIPTION OF THE DRAWINGS

FIG. 1 illustrates a high-level block diagram of an example, non-limiting system that facilitates browserless testing of web servers in accordance with one or more embodiments described herein.

FIG. 2 illustrates a high-level block diagram of an example, non-limiting system including an HTTP request message and an HTTP response message that facilitates browserless testing of web servers in accordance with one or more embodiments described herein.

FIG. 3 illustrates a high-level block diagram of an example, non-limiting system including a header mapping and a modified HTTP request message that facilitates browserless testing of web servers in accordance with one or more embodiments described herein.

FIG. 4 illustrates, in an exemplary and non-limiting way, how a header mapping can be used to preprocess an HTTP request message in accordance with one or more embodiments described herein.

FIG. 5 illustrates a high-level block diagram of an example, non-limiting system including an HTTP response message that facilitates browserless testing of web servers in accordance with one or more embodiments described herein.

FIG. 6 illustrates a high-level block diagram of an example, non-limiting system including a body comparison that facilitates browserless testing of web servers in accordance with one or more embodiments described herein.

FIG. 7 illustrates a high-level block diagram of an example, non-limiting system including a mapping component and a header comparison that facilitates browserless testing of web servers in accordance with one or more embodiments described herein.

FIG. 8 illustrates a high-level block diagram of an example, non-limiting system including an alert component that facilitates browserless testing of web servers in accordance with one or more embodiments described herein.

FIG. 9 illustrates a high-level flow diagram of an example, non-limiting computer-implemented method that facilitates browserless testing of web servers in accordance with one or more embodiments described herein.

FIG. 10 illustrates a high-level communication diagram of an example, non-limiting workflow that facilitates browserless testing of web servers in accordance with one or more embodiments described herein.

FIG. 11 illustrates a block diagram of an example, non-limiting operating environment in which one or more embodiments described herein can be facilitated.

FIG. 12 illustrates an example networking environment operable to execute various implementations described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background section, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In the field of computing, a server can be any suitable combination of computer hardware and/or computer software that can provide functionality (e.g., that can perform computations and/or computing actions, called services) for a client device, which itself can be any suitable combination of computer hardware and/or computer software (e.g., the client device can be a laptop computer, a desktop computer, a smart phone, a smart watch, a tablet device, a vehicle-integrated computer). In various aspects, a web server can be a server that is dedicated to electronically storing, processing, and/or delivering web resources (e.g., any identifiable information or service, such as a webpage) to client devices over the World Wide Web. A web server can communicate with a client device via any suitable Internet protocol suite, such as Hypertext Transfer Protocol (e.g., HTTP, HTTPS, and/or so on), Dynamic Host Configuration Protocol (DHCP), File Transfer Protocol (FTP), and/or any other suitable communication protocol over the Transmission Control Protocol and the Internet Protocol (TCP/IP). It is noted that although the examples discussed herein refer to various HTTP messages, these are provided as non-limiting and illustrative examples only. In various aspects, any other suitable protocols can be implemented in addition to, or instead of, HTTP.

In various cases, a client device can execute a software application referred to as a browser (also referred to as a web browser). A browser can fetch and/or render web resources that are delivered by web servers. To facilitate this functionality, the browser can include a user interface, a browsing engine, and a rendering engine. The user interface of the browser can receive manual input (e.g., mouse clicks, button presses, screen-touches, voice commands) from a human operator of the client device, which manual input can correspond to and/or otherwise indicate a desired web resource. For example, the human operator can type a web address (e.g., uniform resource locator (URL)) of a webpage into the user interface of the browser (e.g., into an address bar of the user interface). As another example, the human operator can click on forward and/or backward buttons of the user interface to progress and/or return to different webpages. The browsing engine of the browser can then generate an HTTP request message based on the manual input, where the HTTP request message can identify the desired web resource, and the browsing engine can transmit the HTTP request message to a web server.

The web server can generate an HTTP response message based on the HTTP request message, where the HTTP response message contains the desired web resource, and the web server can transmit the HTTP response message back to the browsing engine of the browser. In various aspects, the desired web resource can be expressed in a response message body of the HTTP response message in Hypertext Markup Language (HTML). Once the browsing engine of the browser receives the HTTP response message from the web server, the rendering engine of the browser can visually render the desired web resource of the HTTP response message. For example, the rendering engine can visually display, by using HTML parsers and/or graphical processors, on a computer screen of the client device the desired web resource that is expressed in the response message body of the HTTP response message. In this way, a browser can act as an intermediary between the client device and the web server. Examples of existing browsers include Chrome, Safari, Firefox, Internet Explorer, Opera, Microsoft Edge, Chromium, and/or so on.

When developing and/or updating a web server, automated testing of the web server can be desired, such as to ensure that the web server is functioning properly. As mentioned above, conventional automated testing of a web server is browser-specific. That is, conventional automated testing of a web server involves a testing program that commands a browser to send specific HTTP request messages to the web server and that commands the browser to receive corresponding HTTP response messages from the web server. Once the browser receives the corresponding HTTP response messages from the web server, the browser renders the response message bodies of the corresponding HTTP response messages on a computer screen as webpages. Accordingly, the testing program evaluates the rendered webpages to determine whether the web server is functioning as desired/expected.

However, because the browser includes a user interface that is configured to receive manual input from a human operator, and because the testing program is automated and thus does not provide manual input from a human operator, the testing program does not, alone, interact with the browser. Instead, a browser driver is needed, where the browser driver is a computing software application that is configured to send commands to and receive results from a browser. That is, the browser driver can be configured so as to control and/or otherwise provide input to the user interface of the browser. This results in an unwieldy chain of operation where the testing program interacts with the browser driver, which controls the browser, which fetches and renders web resources from the web server. Moreover, there are many different existing browsers, and each browser is configured differently with different user interfaces. This means that a different browser driver is needed for each different browser that is included in the conventional automated testing system. In fact, even when dealing with a single browser, different browser drivers may be needed based on the implemented version of the browser (e.g., a given browser driver may not be compatible with all released versions of a given browser).

Downloading multiple different browser drivers and/or resolving various version-mismatches and/or other compatibility issues between browsers and browser drivers can be very time-consuming and inefficient, but such hassle occurs in conventional automated testing systems. Systems and/or techniques that can ameliorate these technical problems can thus be desirable.

Various embodiments described herein can address one or more of these technical problems. One or more embodiments described herein include systems, computer-implemented methods, apparatus, and/or computer program products that can facilitate browserless testing of web servers. In various aspects, eliminating browsers from conventional automated testing systems can eliminate the hassle of identifying, downloading, and installing browser drivers corresponding to the browsers. Accordingly, browserless testing systems as described herein can automatically verify the functionality of a web server undergoing testing without having to implement a browser and/or without having to implement a browser driver. In other words, various embodiments described herein can be considered as a computerized testing tool (e.g., a combination of computer hardware and/or computer software) that can interact with a web server without using a browser and that can verify whether the web server is functioning as desired/expected. Because various embodiments described herein can exclude browsers, such embodiments can likewise exclude browser drivers, thereby eliminating the version-mismatch hassle that plagues conventional automated testing systems.

A non-limiting and illustrative example is given below. A deployed web server can serve a client device. In some cases, there can be a web server that is undergoing testing. In various aspects, the web server undergoing testing can be a modified version of the deployed web server, and/or the web server undergoing testing can be a new web server that is planned to replace the deployed web server. In various aspects, embodiments described herein can be considered as a computerized testing tool that can browserlessly validate (e.g., test) the web server undergoing testing, based on the functionality (e.g., the behavior) of the deployed web server. That is, the computerized testing tool can determine whether the functionality of the web server undergoing testing is consistent with the functionality of the deployed web server. In other words, before decommissioning the deployed web server, it can be desired to validate that the new web server that will replace it delivers the same web resources as the deployed web server.

If the functionality of the web server undergoing testing is consistent with that of the deployed web server, the web server undergoing testing can be considered as validated and/or as otherwise properly functioning. That is, if the web server undergoing testing delivers web resources that match those delivered by the deployed web server, the web server undergoing testing can be validated. On the other hand, if the functionality of the web server undergoing testing is not consistent with that of the deployed web server, the web server undergoing testing can be considered as not validated and/or as not otherwise properly functioning. That is, if the web server undergoing testing delivers web resources that do not match those delivered by the deployed web server, the web server undergoing testing can be not validated.

A computerized testing tool that can facilitate such validation can comprise a logging component, a preprocessing component, a transmitter component, a receiver component, and a validation component.

In various instances, the logging component can record (e.g., log) and/or otherwise electronically store an HTTP request message that is generated by the client device and that is transmitted by the client device to the deployed web server. In other words, the client device can be interacting in real-time with the deployed web server by sending requests for web resources to the deployed web server, and the logging component can record such requests.

In various aspects, the logging component can also record and/or otherwise electronically store an HTTP response message that is generated by the deployed web server based on the HTTP request message and that is transmitted by the deployed web server back to the client device. That is, the deployed web server can be interacting with the client device in real-time by sending responses containing the requested web resources to the client device, and the logging component can record such responses.

In various cases, the preprocessing component can modify and/or otherwise electronically edit headers of the HTTP request message, thereby yielding a modified HTTP request message. In various aspects, such modifying and/or otherwise electronically editing can be based on a header mapping that is electronically accessible to the preprocessing component.

In various cases, the HTTP request message can include one or more headers and a request message body. The one or more headers of the HTTP request message can define operating parameters of the HTTP transaction that is occurring between the client device and the deployed web server. For example, the headers can include timestamps, cookies, session IDs, tracking tokens, authentication/credential tokens, syntax and/or data format requirements, cache requirements, response type requirements, and/or so on. On the other hand, the request message body can include substantive content of the HTTP request message, such as a message payload (e.g., a document and/or other web resource) that is written in HTML.

In various cases, because the deployed web server and the web server undergoing testing can be distinct devices, they can be associated with some different operating parameters and thus some different headers. For instance, while the deployed web server and the web server undergoing testing can be associated with the same syntax and/or data format requirements, the same cache requirements, and/or the same response type requirements, they can be associated with different timestamps, different cookies, different session IDs, and/or different tracking tokens.

In various aspects, the header mapping can be any suitable electronic data structure (e.g., relational data structure, graph data structure, hybrid data structure) that lists headers that are unique to the deployed web server and that correlates (e.g., maps) such headers to respectively corresponding headers that are unique to the web server undergoing testing. The preprocessing component can replace headers in the HTTP request message based on the header mapping, thereby resulting in the modified HTTP request message.

For example, the header mapping can list a first session ID that is associated with the deployed web server and can correlate such first session ID to a second session ID that is associated with the web server undergoing testing. Thus, if the HTTP request message contains the first session ID, the preprocessing component can replace the first session ID in the HTTP request message with the second session ID, such that the modified HTTP request message contains the second session ID and not the first session ID. As another example, the header mapping can list a first tracking token that is associated with the deployed web server and can correlate such first tracking token to a second tracking token that is associated with the web server undergoing testing. Thus, if the HTTP request message contains the first tracking token, the preprocessing component can replace the first tracking token with the second tracking token, such that the modified HTTP request message contains the second tracking token and not the first tracking token.

If a header of the HTTP request message is not listed in the header mapping, it can be inferred and/or assumed, in some cases, that such header is the same for both the deployed web server and the web server undergoing testing. For example, the header mapping might not include a header that pertains to data format requirements. Thus, if the HTTP request message contains a header that specifies data format requirements, the preprocessing component can leave that header unchanged, such that the modified HTTP request message contains that same header specifying those data format requirements.

Although the preprocessing component can edit headers of the HTTP request message based on the header mapping, the preprocessing component can, in various cases, refrain from editing the request message body of the HTTP request message, such that the same request message body can be contained in the modified HTTP request message.

In various embodiments, the transmitter component can electronically transmit in any suitable way (e.g., via a wired and/or wireless electronic connection) the modified HTTP request message to the web server undergoing testing. In various cases, however, the transmitter component can facilitate such transmission browserlessly (e.g., in the absence of a browser). In other words, the transmitter component can be any suitable combination of computer hardware and/or computer software that is capable of transmitting electronic data according to any suitable version of Hypertext Transfer Protocol and that itself is not a web browser (e.g., the transmitter component can be any suitable non-browser transmitter device).

In various aspects, the web server undergoing testing can generate an HTTP response message based on the modified HTTP request message, and the receiver component can electronically receive in any suitable way (e.g., via a wired and/or wireless electronic connection) such HTTP response message from the web server undergoing testing. In various cases, however, the receiver component can facilitate such receipt browserlessly (e.g., in the absence of a browser). That is, the receiver component can be any suitable combination of computer hardware and/or computer software that is capable of receiving electronic data according to any suitable version of Hypertext Transfer Protocol and that itself is not a web browser (e.g., the receiver component can be any suitable non-browser receiver device).

In some cases, the transmitter component and the receiver component can be combined into a single transceiver component that can transmit electronic data according to any suitable version of Hypertext Transfer Protocol to the web server undergoing testing, that can receive electronic data according to any suitable version of Hypertext Transfer Protocol from the web server undergoing testing, and that can likewise exclude a web browser (e.g., the transceiver component can be any suitable non-browser transceiver device).

In various embodiments, an HTTP response message can be structured similarly to an HTTP request message. That is, an HTTP response message can include one or more headers and a response message body. The one or more headers of the HTTP response message can define operating parameters of the HTTP transaction that involves the HTTP response message. For instance, the headers can include timestamps, cookies, session IDs, tracking tokens, authentication/credential tokens, syntax and/or data format requirements, cache requirements, request type requirements, and/or so on. In various aspects, the response message body can include substantive content of the HTTP response message, such as a message payload that is written in HTML.

In various instances, the validation component can electronically compare a response message body of the HTTP response message generated by the web server undergoing testing to a response message body of the HTTP response message generated by the deployed web server. In various cases, if the validation component determines that the response message body of the HTTP response message generated by the web server undergoing testing is consistent with the response message body of the HTTP response message generated by the deployed web server, the validation component can conclude that the web server undergoing testing is validated. That is, the validation component can determine that the web server undergoing testing delivered a response with substantive content that is equivalent to that of the response generated by the deployed web server.

On the other hand, if the validation component determines that the response message body of the HTTP response message generated by the web server undergoing testing is not consistent with the response message body of the HTTP response message generated by the deployed web server, the validation component can conclude that the web server undergoing testing is not validated. That is, the validation component can determine that the web server undergoing testing delivered a response with substantive content that is not equivalent to that of the response generated by the deployed web server.

In this way, automated and browserless validation of the web server undergoing testing can be facilitated.

It is noted that, in various aspects, such a computerized testing tool can validate the web server undergoing testing without rendering the HTTP response message generated by the web server undergoing testing and without rendering the HTTP response message generated by the deployed web server. This can be due to the fact that such a computerized testing tool does not incorporate a browser and thus does not include a rendering engine of a browser.

In some embodiments, such a computerized testing tool can comprise a mapping component. In various aspects, the mapping component can electronically compare the headers of the HTTP response message generated by the web server undergoing testing to the headers of the HTTP response message generated by the deployed web server, and the mapping component can electronically update the header mapping based on such comparison. In other words, if the mapping component determines that a given header of the HTTP response message generated by the deployed web server is not equivalent to a corresponding header of the HTTP response message generated by the web server undergoing testing, the mapping component can correlate the given header to the corresponding header, and the mapping component can insert such correlation into the header mapping. On the other hand, if the mapping component determines that the given header is equivalent to the corresponding header, the mapping component can refrain from updating the header mapping. In this way, the header mapping can be continually updated.

For example, the HTTP response message generated by the deployed web server can contain a session ID having a value of X, and the HTTP response message generated by the web server undergoing testing can contain a session ID having a value of Y where X≠Y. This can indicate that the deployed web server and the web server undergoing testing have established different session IDs. In such case, the mapping component can update the header mapping such that the header mapping now correlates the session ID X to the session ID Y. Thus, when the logging component records a future HTTP request message that includes the session ID X, the preprocessing component can replace the session ID X in the future HTTP request message with the session ID Y, such that a future modified HTTP request message includes the session ID Y and not the session ID X.

As a contrasting example, the HTTP response message generated by the deployed web server can contain a syntax requirement A, and the HTTP response message generated by the web server undergoing testing can also contain the syntax requirement A. This can indicate that the syntax requirement is the same for both the deployed web server and the web server undergoing testing. In such case, the mapping component can refrain from adding the syntax requirement A to the header mapping.

In some embodiments, such a computerized testing tool can comprise an alert component. In various aspects, the alert component can electronically generate a validation notification (e.g., a warning and/or other message) based on the determination of the validation component. If the validation component determines that the web server undergoing testing is functioning as expected/desired, the alert component can electronically generate a successful validation notification that indicates that the web server undergoing testing delivered the same web resource as the deployed web server. On the other hand, if the validation component determines that the web server undergoing testing is not functioning as expected/desired, the alert component can electronically generate an unsuccessful validation notification that indicates that the web server undergoing testing did not deliver the same web resource as the deployed web server. In some aspects, the transmitter component can electronically transmit such validation notification to any suitable electronic device, such as to a device associated with an operator of the computerized testing tool.

Overall, a browser includes much superfluous functionality that is not needed when the desire is to test the substantive content of a web resource delivered by a web server and not to test the look-and-feel of a rendered version of the web resource. As mentioned above, a browser can include three components: a user interface, a browsing engine, and a rendering engine. The user interface can include interactive graphical elements that can receive manual input from a human operator. The browsing engine can fetch web resources from a web server by sending HTTP requests based on such manual input to the web server and by receiving HTTP responses based on the HTTP requests from the web server. The rendering engine can visually illustrate on a computer screen the HTTP responses generated by the web server. In various cases, the substantive content of an HTTP response can be evaluated directly by analyzing character strings and/or numerical values in the response message body of the HTTP response; such analysis does not require the message body of the HTTP response to first be rendered. Thus, the rendering engine of a browser can be unnecessary for automated testing of a web server, at least when the look-and-feel of a webpage is not desired to be checked. Moreover, HTTP responses can be received from a web server by first sending to the web server HTTP requests, and such HTTP requests can be automatically generated and/or transmitted without implementing interactive user interface elements such as clickable buttons/icons and/or address bars. Thus, the user interface of a browser can also be unnecessary for automated testing of a web server.

In other words, efficiency benefits can be gained by facilitating automated testing of a web server without using a browser. Specifically, the browser and browser driver of a conventional testing system can be replaced altogether by a much easier-to-manage testing program. Such a testing program can exclude a user interface of a browser, and so no browser drivers are needed with such a testing program. Moreover, such a testing program can exclude a rendering engine.

Instead, the testing program can do the following. There can be a real-world client device that is interacting with a real-world deployed web server; that is, the client device can send HTTP requests to the deployed web server, and the deployed web server can send HTTP responses back to the client device. The testing program can record these HTTP requests and HTTP responses. Next, the testing program can preprocess, based on a header mapping, headers of the recorded HTTP requests, thereby resulting in modified HTTP requests. In various cases, the testing program can then transmit the modified HTTP requests to a web server undergoing testing. The web server undergoing testing can generate HTTP responses, and the testing program can receive the HTTP responses from the web server undergoing testing. Moreover, the testing program can compare message bodies of the HTTP responses generated by the web server undergoing testing to message bodies of the recorded HTTP responses generated by the deployed web server, without rendering any of the responses. If the message bodies are consistent, the web server undergoing testing is validated. If the message bodies are not consistent, the web server undergoing testing has failed validation.

By leaving out the browser, there is no longer a user interface that requires installation of a browser driver. Similarly, by leaving out the rendering engine, time is not wasted on visually displaying responses generated by the deployed web server or the web server undergoing testing. Thus, such a testing program can be more efficient and easier to implement than conventional automated testing systems.

In other words, conventional automated testing systems utilize actual browsers (and browser drivers) during testing, such that they evaluate the web resources that are visually rendered by the browsers. In contrast, various embodiments described herein lack browsers and thus do not visually render any web resources. Instead, various embodiments described herein can utilize a computer program that mimics browser-behavior with respect to the transmission and receipt of HTTP requests and HTTP responses (e.g., the web server undergoing testing can think that it is interacting with a browser) and can evaluate the message bodies of the HTTP responses directly, without rendering.

Various embodiments described herein can be employed to use hardware and/or software to solve problems that are highly technical in nature (e.g., to facilitate browserless testing of web servers), that are not abstract and that cannot be performed as a set of mental acts by a human. Further, some of the processes performed can be performed by a specialized computer (e.g., browserless transmitter, browserless receiver, web servers) for carrying out defined tasks related to browserless testing of web servers.

For example, some aspects of various embodiments described herein can include logging, by a device operatively coupled to a processor, an HTTP request, wherein the HTTP request can be transmitted from a client device to a deployed web server. Moreover, various embodiments can include logging, by the device, a first HTTP response, wherein the first HTTP response is based on the HTTP request and is transmitted from the deployed web server to the client device. In various instances, embodiments described herein can include browserlessly transmitting, by the device, the HTTP request to a web server to be tested. In various cases, the web server to be tested can generate a second HTTP response based on the HTTP request. In various aspects, embodiments can further include browserlessly receiving, by the device, the second HTTP response from the web server to be tested. In various instances, the discussed embodiments can further include comparing, by the device, a first body portion of the first HTTP response to a second body portion of the second HTTP response, without rendering either of the first HTTP response and the second HTTP response.

Such defined tasks are not conventionally performed manually by humans. Indeed, neither the human mind nor a human with pen and paper can electronically record HTTP requests and HTTP responses, can electronically and browserlessly transmit HTTP requests, can electronically and browserlessly receive HTTP responses, and can electronically compare body portions of HTTP responses. Instead, various embodiments described herein are inherently and inextricably tied to computer technology and cannot be implemented outside of a computing environment. Specifically, various embodiments can be considered as an improved computerized tool that can automatically validate web servers without using browsers and without using browser drivers; such a computerized tool cannot be practicably implemented in any sensible way by human beings without computers.

In various instances, embodiments described herein can integrate into a practical application the disclosed teachings regarding browserless testing of web servers. Indeed, in various embodiments, the disclosed teachings can provide a computerized testing tool that can be leveraged by an operator, analyst, and/or software engineer to more easily validate a web server. Specifically, the computerized testing tool can be integrated with a web server undergoing testing and with a deployed web server. In various cases, the computerized testing tool can electronically record HTTP request messages that are received by the deployed web server and HTTP response messages that are generated by the deployed web server. In various aspects, the computerized testing tool can preprocess the recorded HTTP request messages based on a header mapping and can browserlessly transmit the preprocessed HTTP request messages to the web server undergoing testing. The web server undergoing testing can then generate HTTP response messages based on the preprocessed HTTP request messages, and the computerized testing tool can browserlessly receive the HTTP response messages from the web server undergoing testing. In various aspects, the computerized testing tool can then compare, without rendering, message bodies of the HTTP response messages generated by the web server undergoing testing to message bodies of the HTTP response messages generated by the deployed web server. Based on such comparison, the computerized testing tool can determine whether the web server undergoing testing is functioning properly. In various aspects, the computerized testing tool can generate successful and/or unsuccessful validation notifications based on the comparisons. Such a computerized testing tool that can aid operators in validating web servers is certainly a useful and/or practical application of computers.

Moreover, such a computerized testing tool can solve various technical problems in the field of automated web server testing. Specifically, as mentioned above, conventional systems/techniques for automatically testing a web server are browser-dependent and thus require the download and installation of browser drivers. This can be very time-consuming and inefficient (e.g., can involve resolving version-mismatches and/or compatibility issues between browsers and browser drivers). In stark contrast, various embodiments described herein can facilitate browserless automated testing of web servers. As explained herein, a browser can include much superfluous functionality that is not needed when the desire is to test the substantive content generated by a web server and not to test the look-and-feel of webpages generated by a web server. For instance, interactive graphical elements of the user interface of a browser and the rendering engine of a browser can be extraneous to evaluating the substantive content (e.g., character strings and/or numerical values) of web resources, and implementation of such features requires the installation of browser drivers.

Accordingly, various embodiments described herein can leverage this observation by automatically testing a web server without using a browser. Specifically, although HTTP request messages and HTTP response messages are often conventionally transmitted and received via browsers, they are pieces of electronic data that can be transmitted and/or received via any other suitable electronic communication devices. That is, an HTTP request message can be transmitted via any suitable transmitter, and need not only be transmitted by a browser. Similarly, an HTTP response message can be received by any suitable receiver, and need not only be received by a browser. Because various embodiments described herein facilitate testing of web servers without the use of browsers, time and effort need not be spent on downloading/installing browser drivers and/or resolving compatibility issues between browsers and browser drivers, which is a marked advantage over conventional testing systems/techniques. Thus, various embodiments described herein certainly constitute a concrete and tangible technical improvement in the field of web server testing.

It should be appreciated that the figures described herein are exemplary and non-limiting.

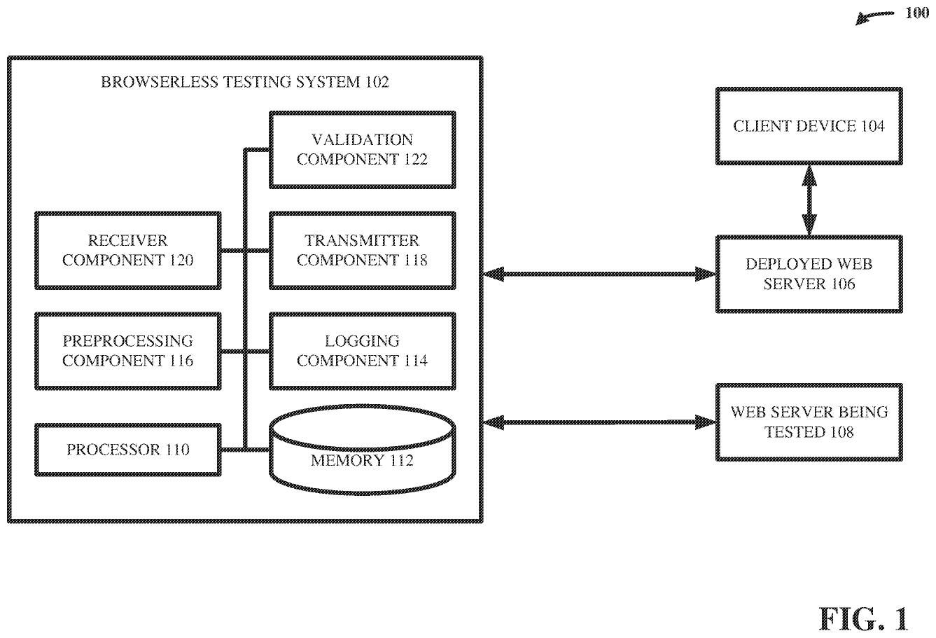

FIG. 1 illustrates a high-level block diagram of an example, non-limiting system 100 that can facilitate browserless testing of web servers in accordance with one or more embodiments described herein. As shown, a client device 104 can be served by a deployed web server 106. In various instances, the client device 104 can be any suitable combination of computer hardware and/or computer software. For instance, the client device 104 can be a laptop computer, a desktop computer, a smart phone, a smart watch, a tablet device, a vehicle-integrated computer, and/or so on. In various cases, the deployed web server 106 can be any suitable combination of computer hardware and/or computer software that can provide any suitable web services to the client device 104. For instance, the deployed web server 106 can electronically store and/or deliver any suitable web resources (e.g., documents, computations) to the client device 104, in response to requests for web resources from the client device 104.

As shown, a browserless testing system 102 can be electronically coupled in any suitable way (e.g., via wired and/or wireless electronic connections) to the deployed web server 106 and to a web server being tested 108. In some cases, the deployed web server 106 can be a server that is operating in a commercial context, and the web server being tested 108 can be a modified version of the deployed web server 106 and/or can be otherwise planned to replace the deployed web server 106. In various aspects, the browserless testing system 102 can automatically validate the functionality of the web server being tested 108 based on the functionality of the deployed web server 106. For example, the browserless testing system 102 can compare the web resources delivered by the web server being tested 108 to the web resources delivered by the deployed web server 106 in order to determine whether the web server being tested 108 is functioning as desired/expected.

In various embodiments, the browserless testing system 102 can comprise a processor 110 (e.g., computer processing unit, microprocessor) and a computer-readable memory 112 that is operably coupled to the processor 110. The memory 112 can store computer-executable instructions which, upon execution by the processor 110, can cause the processor 110 and/or other components of the browserless testing system 102 (e.g., logging component 114, preprocessing component 116, transmitter component 118, receiver component 120, validation component 122) to perform one or more acts. In various embodiments, the memory 112 can store computer-executable components (e.g., logging component 114, preprocessing component 116, transmitter component 118, receiver component 120, validation component 122), and the processor 110 can execute the computer-executable components.

In various embodiments, the browserless testing system 102 can comprise a logging component 114. In various aspects, the client device 104 can electronically generate an HTTP request message (not shown in FIG. 1) that requests a particular web resource, and the client device 104 can electronically transmit the HTTP request message to the deployed web server 106. In various aspects, the logging component 114 can electronically record and/or otherwise store in any suitable data structure the HTTP request message that is transmitted from the client device 104 to the deployed web server 106. For example, the logging component 114 can intercept the HTTP request message as it is transmitted to the deployed web server 106, and/or the deployed web server 106 can relay the HTTP request message to the logging component 114.

In various cases, the HTTP request message can include a request line that indicates a request method and/or that indicates a URL of a web resource. As those having ordinary skill in the art will appreciate, non-limiting examples of request methods can include GET, HEAD, POST, PUT, DELETE, TRACE, OPTIONS, CONNECT, PATCH, and/or so on.

In some instances, the HTTP request message can include one or more headers that specify operating parameters that govern the HTTP transaction that is occurring between the client device 104 and the deployed web server 106. As those having ordinary skill in the art will appreciate, non-limiting examples of such headers can include A-IM, Accept, Accept-Charset, Accept-Datetime, Authorization, Cache-Control, Connection, Content-Encoding, Content-Length, Content-Type, Cookie, Date, Expect, Host, Range, and/or so on.

In some cases, the HTTP request message can include a request message body that specifies substantive content (e.g., a data payload) to be provided by the client device 104 to the deployed web server 106. For example, the request message body can include an input document provided by the client device 104, input data provided by the client device 104, and/or any other suitable information that can be provided by the client device 104 and that can be utilized by the deployed web server 106.

In various instances, the deployed web server 106 can electronically generate a first HTTP response message (not shown in FIG. 1) that is based on the HTTP request message, and the deployed web server 106 can electronically transmit the first HTTP response message back to the client device 104. In various cases, the logging component 114 can electronically record and/or otherwise store in any suitable data structure the first HTTP response message that is transmitted from the deployed web server 106 to the client device 104. For instance, the logging component 114 can intercept the first HTTP response message as it is transmitted to the client device 104, and/or the deployed web server 106 can relay the first HTTP response message to the logging component 114.

In various cases, the first HTTP response message can include a response line that indicates a response method, that indicates a status code (e.g., 1xx for informational, 2xx for successful, 3xx for redirection, 4xx for client error, 5xx for server error, and/or so on), and/or that indicates a URL of a web resource.

In some instances, the first HTTP response message can include one or more headers that specify operating parameters that govern the HTTP transaction that is occurring between the client device 104 and the deployed web server 106. As those having ordinary skill in the art will appreciate, non-limiting examples of such headers can include Access-Control-Allow, Accept-Patch, Accept Ranges, Age, Allow, Alt-Svc, Cache-Control, Connection, Content-Disposition, Content-Encoding, Content-Language, Content-Length, Content-Location, Content-Range, Content-Type, Date, Delta-Base, ETag, Expires, IM, Last-Modified, Link, Location, Public-Key-Pins, Retry-After, Set-Cookie, Upgrade, and/or so on.

In some cases, the first HTTP response message can include a response message body that specifies substantive content (e.g., a data payload) to be delivered by the deployed web server 106 to the client device 104. For instance, the response message body can include an output document delivered by the deployed web server 106, output data delivered by the deployed web server 106, and/or so on. In such case, the output document and/or the output data can be considered as the web resource that was requested by the client device 104.

In some cases, the logging component 114 can co-relate the HTTP request message and the first HTTP response message as a data pair (e.g., by assigning respective correlation identifiers to the HTTP request message and the first HTTP response message), and the logging component 114 can persist such data pair for any suitable period of time.

In various embodiments, the browserless testing system 102 can comprise a preprocessing component 116. In various aspects, the preprocessing component 116 can electronically modify (e.g., edit) headers of the HTTP request message based on a header mapping, thereby yielding a modified HTTP request message. In various aspects, the preprocessing component 116 can electronically store and/or have any other suitable form of electronic access to the header mapping.

In various instances, the header mapping can correlate (e.g., map) headers associated with the deployed web server 106 to respectively corresponding headers associated with the web server being tested 108. In various cases, the preprocessing component 116 can modify a header of the HTTP request message by replacing such header with a respectively corresponding header indicated in the header mapping. In other words, the header mapping can indicate that particular headers that are associated with the deployed web server 106 are supposed to be replaced by other particular headers that are associated with the web server being tested 108.

For instance, the header mapping can indicate that a tracking token M is correlated with a tracking token N. In such case, if the HTTP request message has in its headers the tracking token M, the preprocessing component can replace it with the tracking token N, such that the headers of the modified HTTP request message include the tracking token N and not the tracking token M.

In various cases, the modified HTTP request message can be considered as having the same request message body as the HTTP request message (e.g., same substantive content) but some different headers (e.g., different session IDs, different timestamps, different tracking tokens, different cookies, and/or so on).

In various embodiments, the browserless testing system 102 can comprise a transmitter component 118. In various aspects, the transmitter component 118 can electronically and browserlessly transmit in any suitable way the modified HTTP request message to the web server being tested 108. As explained above, the modified HTTP request message is electronic data and can thus be transmitted in any suitable fashion to the web server being tested 108 (e.g., a browser is not required in order to transmit the modified HTTP request message).

Once the web server being tested 108 receives the modified HTTP request message, the web server being tested 108 can generate a second HTTP response message based on the modified HTTP request message. For instance, the modified HTTP request message can request a particular web resource, and the second HTTP response message can contain that particular web resource.

In various embodiments, the browserless testing system 102 can comprise a receiver component 120. In various aspects, the receiver component 120 can electronically and browserlessly receive in any suitable way the second HTTP response message from the web server being tested 108. As explained above, the second HTTP response message is electronic data and can thus be received in any suitable fashion from the web server being tested 108 (e.g., a browser is not required in order to receive the modified HTTP request message).

In some cases, the transmitter component 118 and the receiver component 120 can be combined into a single transceiver component (not shown in FIG. 1) that can transmit, without using a browser or browser driver, the modified HTTP request message and that can receive, without using a browser or browser driver, the second HTTP response message.

In any case, because the transmitter component 118 and the receiver component 120 do not incorporate any web browsers, they do not include any user interface elements of a browser and do not render web resources delivered by the web server being tested 108 in the same way that a browser does. However, the transmitter component 118 and the receiver component 120 can nevertheless electronically transmit HTTP request messages to and electronically receive HTTP response messages from the web server being tested 108.

In various embodiments, the browserless testing system 102 can comprise a validation component 122. In various aspects, the validation component 122 can electronically compare a response message body of the first HTTP response message to a response message body of the second HTTP response message. More specifically, the validation component 122 can compare character strings and/or numerical values in the response message body of the first HTTP response message to corresponding character strings and/or corresponding numerical values in the response message body of the second HTTP response message. In other words, the validation component 122 can compare the web resource delivered by the deployed web server 106 to the web resource delivered by the web server being tested 108. Based on this comparison, the validation component 122 can determine whether or not the web server being tested 108 is functioning properly (e.g., whether the web server being tested 108 is delivering expected web resources).

If the response message body of the first HTTP response message is consistent with the response message body of the second HTTP response message, the validation component 122 can determine that the web server being tested 108 functioned appropriately. On the other hand, if the response message body of the first HTTP response message is not consistent with the response message body of the second HTTP response message, the validation component 122 can determine that the web server being tested 108 failed to function appropriately.

In various aspects, the validation component 122 can refrain from comparing headers of the first HTTP response message to headers of the second HTTP response message.

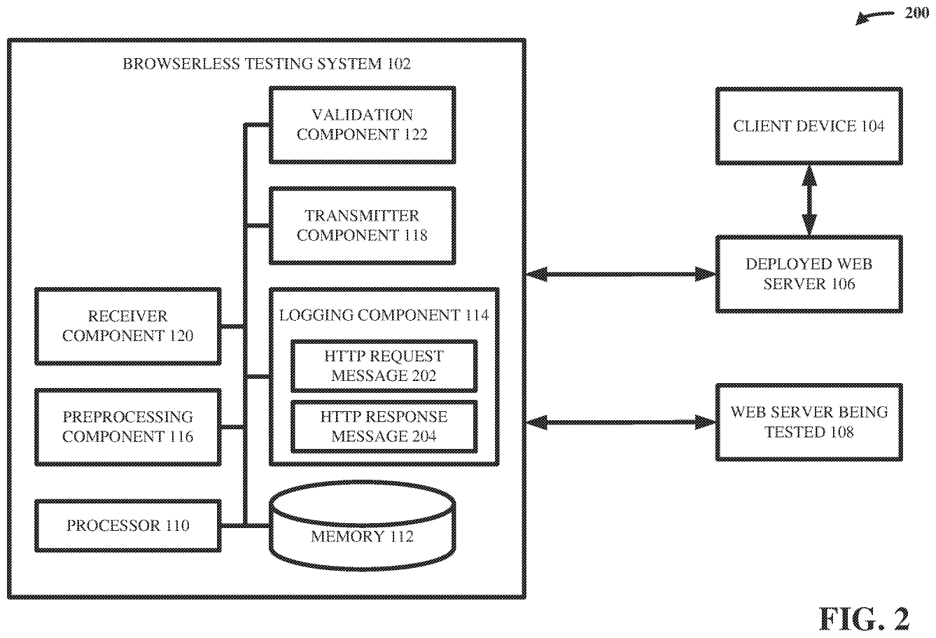

FIG. 2 illustrates a high-level block diagram of an example, non-limiting system 200 including an HTTP request message and an HTTP response message that can facilitate browserless testing of web servers in accordance with one or more embodiments described herein. As shown, the system 200 can, in some cases, comprise the same components as the system 100, and can further comprise an HTTP request message 202 and an HTTP response message 204.

In various aspects, as mentioned above, the client device 104 can electronically generate the HTTP request message 202 and can electronically transmit the HTTP request message 202 to the deployed web server 106. Moreover, in various aspects, the deployed web server 106 can electronically generate the HTTP response message 204 based on the HTTP request message 202, and the deployed web server 106 can electronically transmit the HTTP response message 204 to the client device 104. In other words, an HTTP transaction between the client device 104 and the deployed web server 106 can occur, in which the client device 104 requests a particular web resource from the deployed web server 106 (e.g., the HTTP request message 202 can identify the requested web resource, and the HTTP response message 204 can deliver the requested web resource).

In various aspects, the HTTP request message 202 can have any suitable properties of HTTP request messages already described above (e.g., request line, headers, and/or request message body containing a request payload written in HTML). Similarly, the HTTP response message 204 can have any suitable properties of HTTP response messages already described above (e.g., response line, headers, and/or response message body containing a response payload written in HTML).

In various instances, the logging component 114 can electronically record and/or otherwise store both the HTTP request message 202 and the HTTP response message 204. In some cases, the logging component 114 can intercept the HTTP request message 202 as it is being transmitted from the client device 104 to the deployed web server 106. In some cases, the logging component 114 can similarly intercept the HTTP response message 204 as it is being transmitted from the deployed web server 106 to the client device 104. In other cases, the deployed web server 106 can electronically relay one or both of the HTTP request message 202 and the HTTP response message 204 to the logging component 114.

In various aspects, as explained herein, a second HTTP transaction can occur between the web server being tested 108 and the browserless testing system 102, and the functionality of the web server being tested 108 can be validated by comparing this second HTTP transaction with the HTTP transaction occurring between the client device 104 and the deployed web server 106.

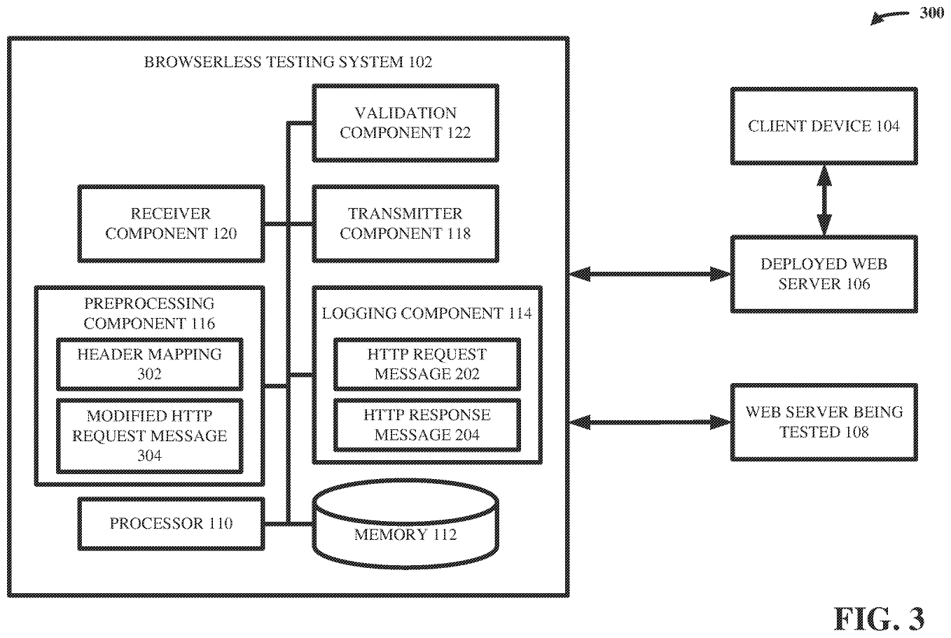

FIG. 3 illustrates a high-level block diagram of an example, non-limiting system 300 including a header mapping and a modified HTTP request message that can facilitate browserless testing of web servers in accordance with one or more embodiments described herein. As shown, the system 300 can, in some cases, comprise the same components as the system 200, and can further comprise a header mapping 302 and a modified HTTP request message 304.

In various embodiments, the preprocessing component 116 can electronically store and/or otherwise have access to the header mapping 302, and the preprocessing component 116 can generate the modified HTTP request message 304 based on both the HTTP request message 202 and the header mapping 302. In various aspects, the header mapping 302 can be any suitable data structure (e.g., relational data structure, graph data structure, hybrid data structure) that correlates a first set of headers to a second set of headers.

In various instances, the first set of headers can be associated with the deployed web server 106. For example, the first set of headers can include session IDs, tracking tokens, cookies, and/or any other parameters and/or metadata that govern the HTTP transaction between the client device 104 and the deployed web server 106. In contrast, the second set of headers can be associated with the web server being tested 108. For instance, the second set of headers can include session IDs, tracking tokens, cookies, and/or any other parameters and/or metadata that govern the HTTP transaction between the browserless testing system 102 and the web server being tested 108.

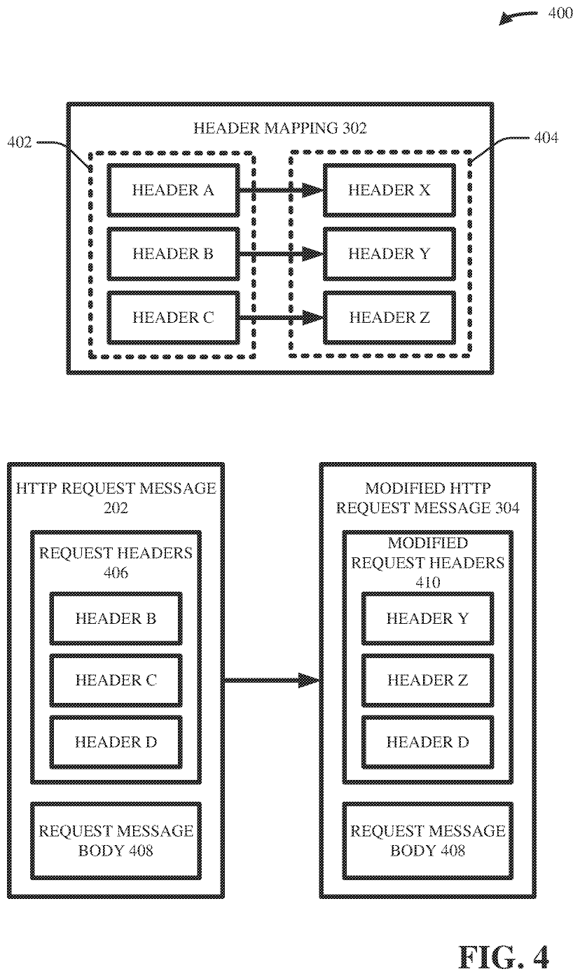

In various cases, the preprocessing component 116 can electronically generate the modified HTTP request message 304 by electronically replacing headers of the HTTP request message 202 that are included in the first set of headers of the header mapping 302 with respectively corresponding headers that are included in the second set of headers of the header mapping 302. This is non-limitingly illustrated in FIG. 4.

FIG. 4 illustrates, in an exemplary and non-limiting way, how a header mapping can be used to preprocess an HTTP request message in accordance with one or more embodiments described herein. In other words, FIG. 4 depicts an exemplary and non-limiting embodiment of the header mapping 302, an exemplary and non-limiting embodiment of the HTTP request message 202, and an exemplary and non-limiting embodiment of the modified HTTP request message 304.

As shown, the header mapping 302 can comprise a first set of headers 402 and a second set of headers 404. In various aspects, the first set of headers 402 can be associated with the deployed web server 106. That is, the first set of headers 402 can specify operating parameters and/or metadata that govern the HTTP transaction between the client device 104 and the deployed web server 106. In various instances, the second set of headers 404 can be associated with the web server being tested 108. That is, the second set of headers 404 can specify operating parameters and/or metadata that govern the HTTP transaction between the browserless testing system 102 and the web server being tested 108).

For instance, the first set of headers 402 can include a header A, a header B, and/or a header C. In some cases, the header A can be a session ID A established by the deployed web server 106, the header B can be a tracking token B established by the deployed web server 106, and the header C can be a cookie C established by the deployed web server 106.

Similarly, the second set of headers 404 can include a header X, a header Y, and/or a header Z. In some cases, the header X can be a session ID X established by the web server being tested 108 where A≠X, the header Y can be a tracking token Y established by the web server being tested 108 where B≠Y, and the header Z can be a cookie Z established by the web server being tested 108, where C≠Z.

In various aspects, as shown, the first set of headers 402 can be respectively correlated with the second set of headers 404. For example, the header A can be correlated to the header X, the header B can be otherwise correlated to the header Y, and/or the header C can be correlated to the header Z. Such correlations can indicate that specific headers in the first set of headers 402 are supposed to be replaced (e.g., via the preprocessing component 116) with respectively corresponding headers in the second set of headers 404. For instance, because the header A is correlated with the header X, whenever an HTTP request message contains the header A, the preprocessing component 116 can replace it with the header X. Similarly, because the header B is correlated with the header Y, whenever an HTTP request message contains the header B, the preprocessing component 116 can replace it with the header Y. Likewise, because the header C is correlated with the header Z, whenever an HTTP request message contains the header C, the preprocessing component 116 can replace it with the header Z.

Such replacement is non-limitingly illustrated in FIG. 4. As shown, the HTTP request message 202 can, in some cases, comprise request headers 406 and a request message body 408. In some instances, the request headers 406 can include the header B (e.g., the tracking token B), the header C (e.g., the cookie C), and a header D (e.g., a content-type D). The preprocessing component 116 can electronically edit the HTTP request message 202 based on the header mapping 302 in order to generate the modified HTTP request message 304. Specifically, the preprocessing component 116 can use the header mapping 302 to edit the request headers 406 of the HTTP request message 202, thereby resulting in the modified HTTP request message 304 having modified request headers 410.

For instance, because the HTTP request message 202 can have the header B, and because the header mapping 302 can indicate that the header B is correlated with the header Y, the preprocessing component 116 can replace the header B in the HTTP request message 202 with the header Y, such that the modified HTTP request message 304 includes the header Y and not the header B. If the header B and the header Y represent tracking tokens, this can mean that the HTTP transaction between the client device 104 and the deployed web server 106 involves a different tracking token than does the HTTP transaction between the browserless testing system 102 and the web server being tested 108.

Similarly, because the HTTP request message 202 can have the header C, and because the header mapping 302 can indicate that the header C is correlated with the header Z, the preprocessing component 116 can replace the header C in the HTTP request message 202 with the header Z, such that the modified HTTP request message 304 includes the header Z and not the header C. If the header C and the header Z represent cookies, this can mean that the HTTP transaction between the client device 104 and the deployed web server 106 involves a different cookie than does the HTTP transaction between the browserless testing system 102 and the web server being tested 108.

It is noted that, in various aspects, the header D is not listed in the header mapping 302. Thus, the preprocessing component 116 can refrain from editing the header D in the HTTP request message 202, thereby causing the modified HTTP request message 304 to have the same header D. If the header D represents a content-type requirement, this can mean that the HTTP transaction between the client device 104 and the deployed web server 106 involves a same content-type requirement as does the HTTP transaction between the browserless testing system 102 and the web server being tested 108.

Furthermore, it is noted that the preprocessing component 116 can refrain from editing the request message body 408 of the HTTP request message 202, thereby causing the modified HTTP request message 304 to have the same request message body 408.

Although FIG. 4 illustrates only three headers in each of the first set of headers 402 and the second set of headers 404, this is exemplary and non-limiting. In various aspects, each of the first set of headers 402 and the second set of headers 404 can have any suitable numbers and/or types of headers. Although FIG. 4 illustrates only three headers in each of the HTTP request message 202 and the modified HTTP request message 304, this is exemplary and non-limiting. In various instances, each of the HTTP request message 202 and the modified HTTP request message 304 can have any suitable numbers and/or types of headers.

In various embodiments, once the preprocessing component 116 electronically generates the modified HTTP request message 304, the transmitter component 118 can electronically transmit, using neither a browser nor a browser driver, the modified HTTP request message 304 to the web server being tested 108. As explained above, an HTTP message is a collection of data that can be electronically transmitted via any suitable transmitter device (e.g., although HTTP messages are often transmitted via browsers, browsers are not required for the transmission of HTTP messages).

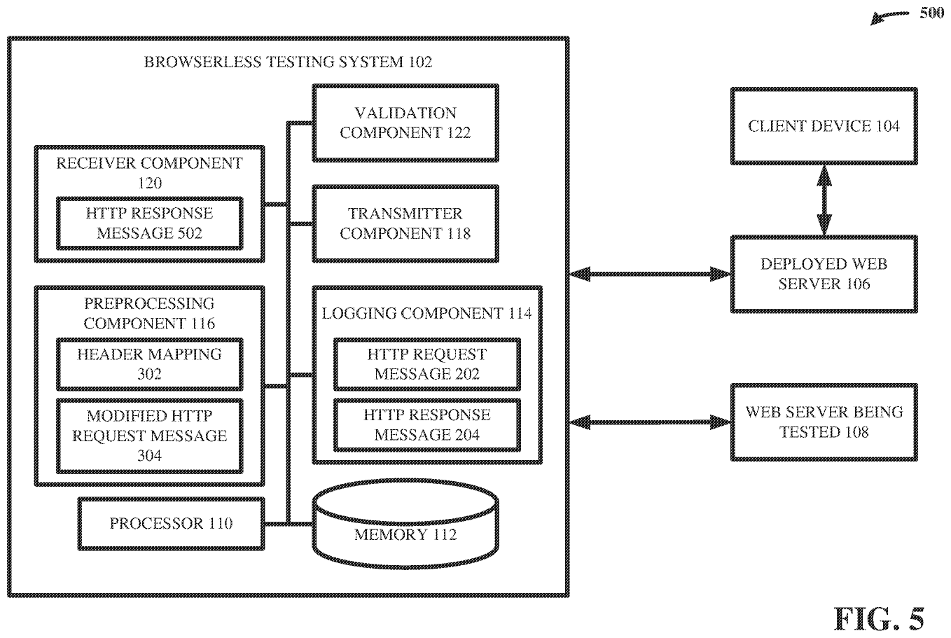

FIG. 5 illustrates a high-level block diagram of an example, non-limiting system 500 including an HTTP response message that can facilitate browserless testing of web servers in accordance with one or more embodiments described herein. As shown, the system 500 can, in some cases, comprise the same components as the system 300, and can further comprise an HTTP response message 502.

In various aspects, after the transmitter component 118 browserlessly transmits the modified HTTP request message 304 to the web server being tested 108, the web server being tested 108 can electronically generate the HTTP response message 502 based on the modified HTTP request message 304. In various aspects, the receiver component 120 can electronically receive, using neither a browser nor a browser driver, the HTTP response message 502 from the web server being tested 108. As explained above, an HTTP message is a collection of data that can be electronically received via any suitable receiver device (e.g., although HTTP messages are often received by browsers, browsers are not required for the receipt of HTTP messages).

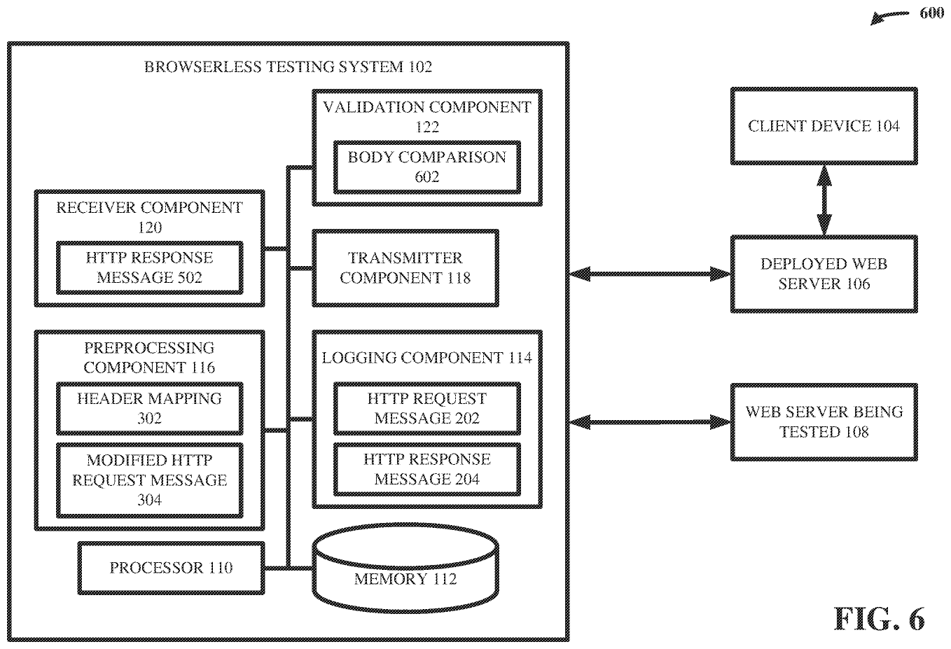

FIG. 6 illustrates a high-level block diagram of an example, non-limiting system 600 including a body comparison that can facilitate browserless testing of web servers in accordance with one or more embodiments described herein. As shown, the system 600 can, in some cases, comprise the same components as the system 500, and can further comprise a body comparison 602.

In various aspects, the validation component 122 can compare, via any suitable comparison technique such as Longest Common Subsequence, a response message body of the HTTP response message 502 with a response message body of the HTTP response message 204, thereby yielding the body comparison 602. As explained above, the web server being tested 108 can, in some cases, be a modified version of the deployed web server 106 and/or can otherwise be planned to replace the deployed web server 106 in a commercial context. Accordingly, it can be desired to ensure that the web server being tested 108 is delivering web resources that are consistent with those delivered by the deployed web server 106. That is, it can be desired to ensure that the HTTP response message 502 is consistent with the HTTP response message 204.

In various cases, the HTTP response message 502 can be considered as consistent with the HTTP response message 204 if character strings and/or numerical values included in the response message body of the HTTP response message 502 match and/or are otherwise equivalent with corresponding character strings and/or numerical values in the response message body of the HTTP response message 204.

Based on this comparison (e.g., based on the body comparison 602), the validation component 122 can electronically determine whether the web server being tested 108 is functioning properly. For example, if the body comparison 602 indicates that all character strings and/or numerical values of the response message body of the HTTP response message 502 are equivalent to corresponding character strings and/or numerical values of the response message body of the HTTP response message 204, the validation component 122 can conclude that the web server being tested 108 functioned properly. That is, the validation component 122 can determine that the web server being tested 108 delivered the same web resource as the deployed web server 106. In contrast, if the body comparison 602 indicates that some character strings and/or numerical values of the response message body of the HTTP response message 502 are not equivalent to corresponding character strings and/or numerical values of the response message body of the HTTP response message 204, the validation component 122 can conclude that the web server being tested 108 functioned improperly. That is, the validation component 122 can determine that the web server being tested 108 delivered a different web resource than the deployed web server 106.

In some cases, the validation component 122 can be trained and/or programmed to ignore substantively immaterial portions of the response message body of the HTTP response message 502 and of the response message body of the HTTP response message 204. For instance, a webpage can perform a particular service for a client. In various aspects, initiation of the webpage during the morning hours can cause the webpage to generate a “Good morning” notification prior to performing the particular service, and such a “Good morning” notification would be indicated in some fashion in the message body of an HTTP response message. In some cases, initiation of the webpage during the afternoon hours can cause the webpage to generate a “Good afternoon” notification prior to performing the particular service, and such a “Good afternoon” notification would be indicated in some fashion in the message body of an HTTP response message. Moreover, initiation of the webpage during the evening hours can cause the webpage to generate a “Good evening” notification prior to performing the particular service, and such a “Good evening” notification would be indicated in some fashion in the message body of an HTTP response message. In any of these cases, the substantive content that the validation component 122 evaluates would be character strings and/or numerical values that are relevant to the particular service, and would not include the character strings that pertain to these “Good morning,” “Good afternoon,” or “Good evening” notifications. This can be because such time-based notifications can be not substantively related to the particular service delivered by the webpage.

Thus, in various aspects, the response message body of the HTTP response message 502 can be considered as consistent with the response message body of the HTTP response message 204, even if such response message bodies are not completely identical. In other words, the response message body of the HTTP response message 502 can be consistent with the response message body of the HTTP response message 204 if the substantively relevant character strings and/or numerical values in the response message bodies match, notwithstanding that the substantively irrelevant character strings and/or numerical values in the response message bodies might not match. In various aspects, character strings and/or numerical values can be substantively relevant if they are related to the underlying service being provided by the web server being tested 108 and/or by the deployed web server 106.

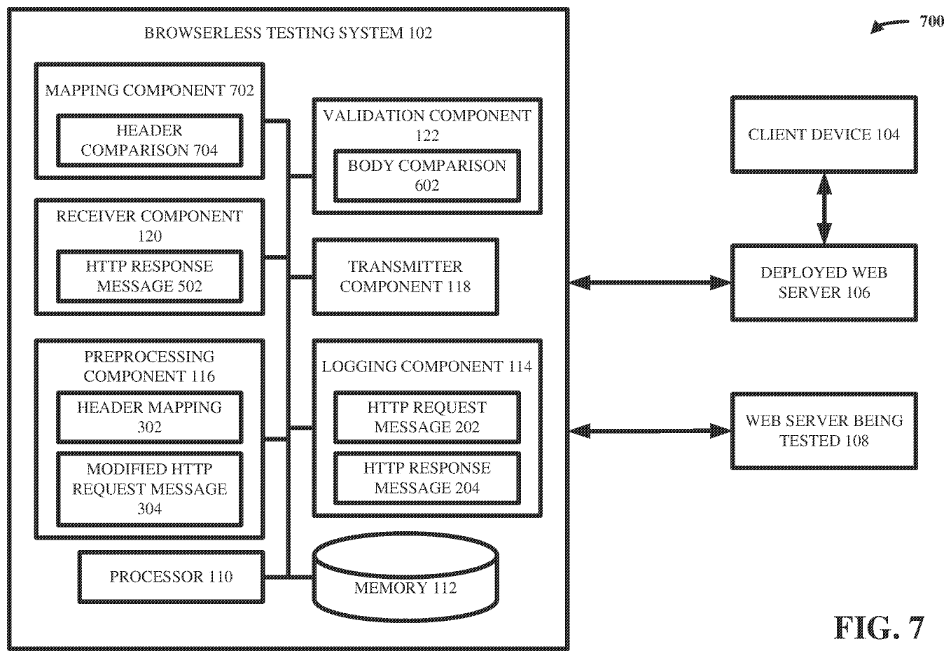

FIG. 7 illustrates a high-level block diagram of an example, non-limiting system 700 including a mapping component and a header comparison that can facilitate browserless testing of web servers in accordance with one or more embodiments described herein. As shown, the system 700 can, in some cases, comprise the same components as the system 700, and can further comprise a mapping component 702.

In various embodiments, the mapping component 702 can electronically update the header mapping 302 based on headers of the HTTP response message 502 and headers of the HTTP response message 204. As explained above, it can be desired to ensure that the web server being tested delivers web resources that are consistent with (e.g., that match) those delivered by the deployed web server 106. This can mean that it is desired that the response message body of the HTTP response message 502 is consistent with (e.g., matches) the response message body of the HTTP response message 204. However, various headers of the HTTP response message 502 and the HTTP response message 204 can be different and thus inconsistent (e.g., different session IDs, different tracking tokens, different cookies, different timestamps). In various aspects, the mapping component 702 can compare, via any suitable comparison technique such as Longest Common Subsequence, the headers of the HTTP response message 502 and the headers of the HTTP response message 204, thereby yielding the header comparison 704.

The mapping component 702 can then update the header mapping 302 based on the header comparison 704. That is, if the mapping component 702 determines that a particular header of the HTTP response message 204 is different from a corresponding header of the HTTP response message 502, and if the mapping component 702 determines that the particular header and the corresponding header are not yet listed in the header mapping 302, the mapping component 702 can insert the particular header and the corresponding header into the header mapping 302. Accordingly, when a future HTTP request message includes the particular header, the preprocessing component 116 will be able to replace the particular header with the corresponding header when generating a future modified HTTP request message.

For example, suppose that the header mapping 302 does not yet include session IDs (e.g., the HTTP transactions involved can be new and thus session IDs may not have been assigned yet). If the HTTP response message 204 includes a session ID Q and the HTTP response message 502 includes a session ID R, the mapping component 702 can determine that these session IDs do not match and can thus add both the session ID Q and the session ID R to the header mapping 302. Accordingly, when a future HTTP request message is captured by the logging component 114 that includes the session ID Q, the preprocessing component 116 can replace it with the session ID R when generating a future modified HTTP request message.

In some embodiments, not all different headers need to be added to the header mapping 302. For instance, headers that differ between the HTTP response message 502 and the HTTP response message 204 and that identify information that will be referenced and/or needed later on during an HTTP transaction can be included in the header mapping 302. On the other hand, headers that differ between the HTTP response message 502 and the HTTP response message 204 but that identify information that will not be referenced and/or needed later on during an HTTP transaction can be excluded from the header mapping 302.

For example, different session IDs, tracking tokens, and/or cookies can be established by the web server being tested 108 and the deployed web server 106, and such session IDs, tracking tokens, and/or cookies can be required to be presented to the web server being tested 108 or to the deployed web server 106 (as the case may be) at some future point. This can be because session IDs, tracking tokens, and/or cookies are usually needed to facilitate an extended HTTP transaction. Accordingly, such headers can be included in the header mapping 302.

In contrast, different timestamps can be established by the web server being tested 108 and the deployed web server 106, but such timestamps can be generally not required to be presented to the web server being tested 108 or to the deployed web server 106 (as the case may be) at some future point. This can be because timestamps are usually not needed to facilitate an extended HTTP transaction. Accordingly, such headers can be excluded from the header mapping 302.

In some cases, the mapping component 702 can be preprogrammed to know which headers to include and/or exclude from the header mapping 302. In other cases, the mapping component 702 can learn, via any suitable technique such as regex patterns, which headers to include and/or exclude over time.

In this way, the mapping component 702 can update the header mapping 302 based on previous HTTP response messages generated by the web server being tested 108 and based on previous HTTP response messages generated by the deployed web server 106, and the header mapping 302 can be leveraged by the preprocessing component 116 to edit the headers of future HTTP request messages.

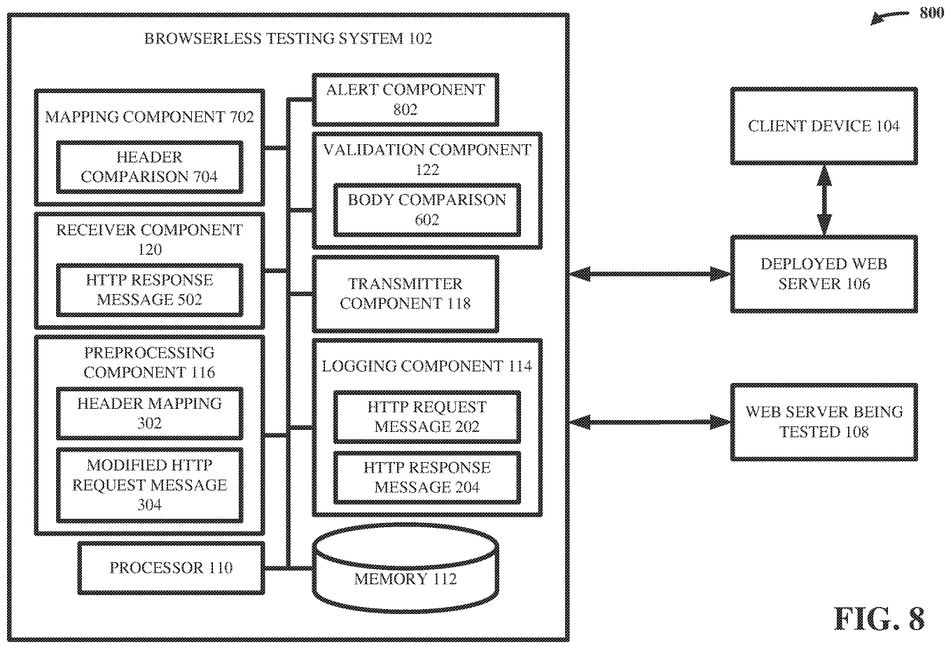

FIG. 8 illustrates a high-level block diagram of an example, non-limiting system 800 including an alert component that can facilitate browserless testing of web servers in accordance with one or more embodiments described herein. As shown, the system 800 can, in some cases, comprise the same components as the system 700, and can further comprise an alert component 802.

In various embodiments, the alert component 802 can electronically generate any suitable notification based on the determinations of the validation component 122. For instance, if the validation component 122 determines that the response message body of the HTTP response message 502 is consistent with the response message body of the HTTP response message 204, the alert component 802 can generate a successful validation notification indicating that the web server being tested 108 functioned properly. In other words, a successful validation notification can indicate that the web server being tested 208 delivered the same web resource as the deployed web server 106.

On the other hand, if the validation component 122 determines that the response message body of the HTTP response message 502 is not consistent with the response message body of the HTTP response message 204, the alert component 802 can generate an unsuccessful validation notification indicating that the web server being tested 108 functioned improperly. In other words, such an unsuccessful validation notification can indicate that the web server being tested 108 delivered a different web resource than the deployed web server 106. In various aspects, the transmitter component 118 can electronically transmit such notifications to any computing device, such as to a computing device associated with an operator of the web server being tested 108.

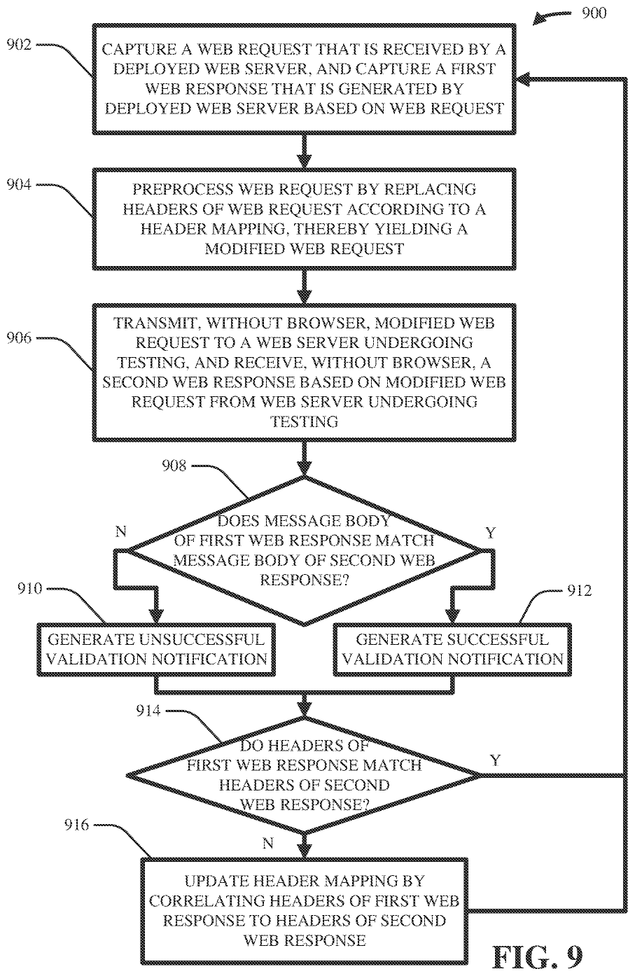

FIG. 9 illustrates a high-level flow diagram of an example, non-limiting computer-implemented method 900 that can facilitate browserless testing of web servers in accordance with one or more embodiments described herein.

In various embodiments, act 902 can include capturing, by a device operatively coupled to a processor (e.g., via 114), a web request (e.g., 202) that is received by a deployed web server (e.g., 106), and capturing, by the device (e.g., via 114), a first web response (e.g., 204) that is generated by the deployed web server based on the web request.

In various aspects, act 904 can include preprocessing, by the device (e.g., via 116), the web request by replacing headers (e.g., 406) of the web request according to a header mapping (e.g., 302), thereby yielding a modified web request (e.g., 304).

In various instances, act 906 can include transmitting, by the device (e.g., via 118) and without a browser, the modified web request to a web server undergoing testing (e.g., 108), and receiving, by the device (e.g., via 120) and without a browser, a second web response (e.g., 502) based on the modified web request from the web server undergoing testing.

In various cases, act 908 can include determining, by the device (e.g., 122), whether a message body of the first web response matches a message body of the second web response. If not, the computer-implemented method 900 can proceed to act 910. If so, the computer-implemented method 900 can proceed to act 912.

In various aspects, act 910 can include generating, by the device (e.g., via 802), an unsuccessful validation notification.

In various instances, act 912 can include generating, by the device (e.g., via 802), a successful validation notification.

In various cases, act 914 can include determining, by the device (e.g., via 802), whether headers of the first web response match headers of the second web response. If not, the computer-implemented method 900 can proceed to act 916. If so, the computer-implemented method 900 can proceed back to act 902.

In various aspects, act 916 can include updating, by the device (e.g., via 702), the header mapping by correlating headers of the first web response to headers of the second web response. In various aspects, the computer-implemented method 900 can proceed back to act 902.

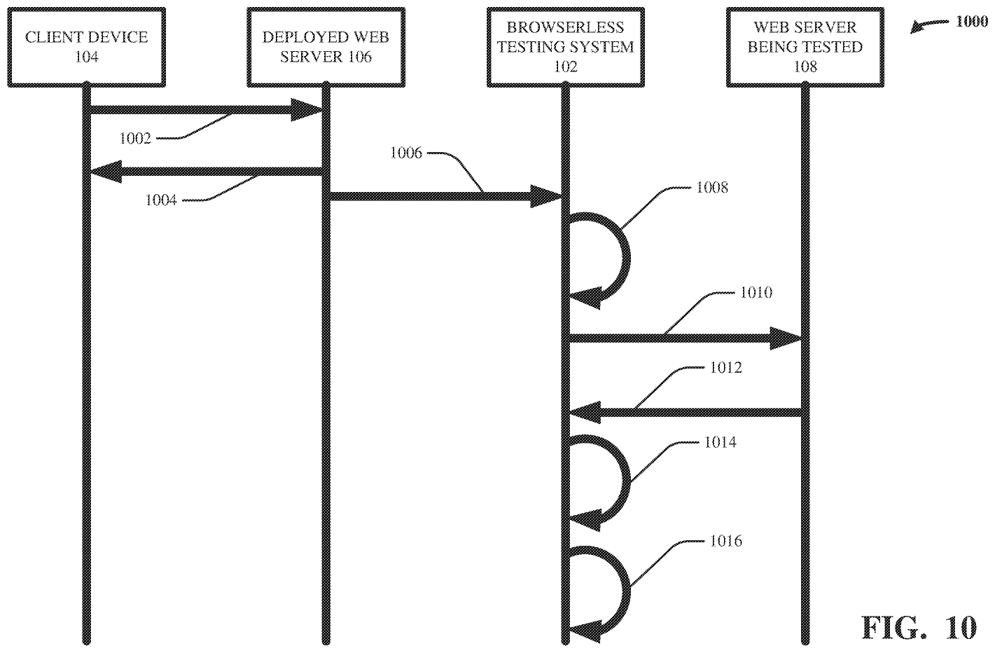

FIG. 10 illustrates a high-level communication diagram of an example, non-limiting workflow 1000 that can facilitate browserless testing of web servers in accordance with one or more embodiments described herein.

In various embodiments, in act 1002, the client device 104 can electronically transmit the HTTP request message 202 to the deployed web server 106.

In various aspects, in act 1004, the deployed web server 106 can electronically transmit the HTTP response message 204 back to the client device 104.

In various instances, in act 1006, the deployed web server 106 can relay both the HTTP request message 202 and the HTTP response message 204 to the browserless testing system 102 (e.g., can be recorded by the logging component 114).

In various cases, in act 1008, the browserless testing system 102 can edit (e.g., via the preprocessing component 116) headers of the HTTP request message 202 based on the header mapping 302, thereby yielding as a result the modified HTTP request message 304.

In various aspects, in act 1010, the browserless testing system 102 can electronically and browserlessly transmit (e.g., via the transmitter component 118) the modified HTTP request message 304 to the web server being tested 108.

In various instances, in act 1012, the browserless testing system 102 can electronically and browserlessly receive (e.g., via the receiver component 120) the HTTP response message 502 from the web server being tested 108.

In various cases, in act 1014, the browserless testing system 102 can compare message bodies of the HTTP response message 502 and the HTTP response message 204 and can accordingly determine, based on such comparison (e.g., 602) whether or not the web server being tested 108 functioned as intended.

In various aspects, in act 1016, the browserless testing system 102 can update the header mapping 302 based on a comparison (e.g., 704) of the headers of the HTTP response message 502 and the headers of the HTTP response message 204.

In various embodiments, the following computer-implemented method can be facilitated by various embodiments described herein. In various aspects, the computer-implemented method can include logging, by a device operatively coupled to a processor (e.g., via 114), a web request (e.g., 202). In various cases, the web request can be transmitted from a client device (e.g., 104) to a deployed web server (e.g., 106).

In various instances, the computer-implemented method can include logging, by the device (e.g., via 114), a first web response (e.g., 204). In various cases, the first web response can be based on the web request and can be transmitted from the deployed web server to the client device.

In various embodiments, the computer-implemented method can include browserlessly transmitting, by the device (e.g., via 118), the web request (e.g., 304 which is derived from 202) to a web server to be tested (e.g., 108). In various cases, the web server to be tested can generate a second web response (e.g., 502) based on the web request.

In various aspects, the computer-implemented method can include browserlessly receiving, by the device (e.g., via 120), the second web response from the web server to be tested.

In various instances, the computer-implemented method can include comparing, by the device (e.g., 122), a first body portion of the first web response to a second body portion of the second web response, without rendering either of the first web response and the second web response.

In various embodiments, the computer-implemented method can include determining, by the device (e.g., 122) and based on the comparing (e.g., 602), that the first body portion of the first web response matches the second body portion of the second web response. In such case, the computer-implemented method can further include generating, by the device (e.g., via 802), a successful verification message indicating that the web server to be tested successfully responded to the web request.

In various embodiments, the computer-implemented method can include determining, by the device (e.g., 122) and based on the comparing (e.g., 602), that the first body portion of the first web response does not match the second body portion of the second web response. In such case, the computer-implemented method can further include generating, by the device (e.g., via 802), an unsuccessful verification message indicating that the web server to be tested unsuccessfully responded to the web request.

In various embodiments, the computer-implemented method can include determining, by the device (e.g., via 702), that a first header of the first web response does not match a second header of the second web response. In such case, the computer-implemented method can further include correlating, by the device (e.g., via 702), the first header of the first web response to the second header of the second web response. This can yield a mapping (e.g., 302) that can indicate that a future header of a future web request is to be replaced with the second header of the second web response when the future header of the future web request is equivalent to the first header of the first web response (e.g., discussed with respect to FIG. 7).

In various embodiments, the computer-implemented method can include modifying, by the device (e.g., via 116), the web request before transmitting the web request to the web server to be tested. In various cases, such modification can include replacing a header (e.g., 406) of the web request with a prior header of a prior web response generated by the web server to be tested (e.g., described with respect to FIG. 4 and FIG. 7; as explained, the header mapping 302 can be generated based on prior headers of prior HTTP response messages).

Although not shown in the figures, in some embodiments, the deployed web server 106 can receive multiple HTTP request messages from multiple client devices. In such case, the browserless testing system 102 can record (e.g., via the logging component 114) all of the HTTP request messages and their corresponding HTTP response messages that are generated by the deployed web server 106. In various instances, the browserless testing system 102 can modify and/or transmit some and/or all of such HTTP request messages to the web server being tested 108 in order to facilitate validation. However, in such case, the browserless testing system 102 can maintain and/or preserve a chronology of the HTTP request messages. For instance, if an HTTP request message E is received by the deployed web server 106 before an HTTP request message F, then a header-modified version of the HTTP request message E can be transmitted to the web server being tested 108 before a header-modified version of the HTTP request message F.

In some cases when multiple HTTP request messages are involved, they can be partitioned according to any suitable criteria (e.g., according to merchant identifiers, according to transaction identifiers, and/or so on) in order to facilitate parallel validation. For example, if an HTTP request message G pertains to a first transaction identifier and is received by the deployed web server 106, and if an HTTP request message H pertains to a second transaction identifier and is received by the deployed web server 106, then a header-modified version of the HTTP request message G can be transmitted to the web server being tested 108 in parallel with a header-modified version of the HTTP request message H.

Automated testing of a web server can be desirable (e.g., can be critical for ensuring proper delivery of requested web resources; can help in identifying bottlenecks and/or software bugs). As explained herein, such automated testing is conventionally dependent upon browsers to establish and maintain a session when carrying out testing of a web server. However, the implementation of a browser requires the download and installation of a corresponding browser driver. Resolving version-mismatches and/or compatibility issues between browsers and browser drivers can be time-consuming and inefficient.

Various embodiments described herein can address this technical problem by eliminating browsers from the automated testing workflow. Instead, various embodiments described herein can take the form of a computing script (e.g., a software program) that can mimic the HTTP behavior of a browser without necessitating the installation of a browser driver. Browserless testing is a concept that automates the execution of web requests (e.g., HTTP request messages) on a web server without involving a browser. Such automation can enable the execution of any web requests without domain knowledge. The execution flow of such browserless testing can be as follows: (1) a client device initiates a web session with a deployed web server by transmitting an HTTP request message to the deployed web server; (2) the deployed web server creates a session and responds back with an HTTP response message that contains the corresponding web resource and/or corresponding cookies/session IDs; (3) the browserless testing system captures the HTTP request message and the HTTP response message; (4) the browserless testing system browserlessly transmits the HTTP request message, after header editing, to a web server undergoing testing; (5) the web server undergoing testing creates a session and responds back with an HTTP response message that contains the corresponding web resource and/or corresponding cookies/session IDs; (6) the browserless testing system browserlessly receives the HTTP response message from the web server undergoing testing; and (7) the browserless testing system compares a body of the HTTP response message of the deployed web server with a body of the HTTP response message of the web server undergoing testing to validate or invalidate the web server undergoing testing.

Although the above description mainly discusses embodiments utilizing HTTP as a communication protocol, this is exemplary and non-limiting. In various aspects, any other suitable communication protocol can be implemented (e.g., HTTP, HTTPS, HTTP/2, Web Real-Time Communication (WebRTC), Quick UDP Internet Connection (QUIC), InterPlanetary File System (IPFS), and/or so on). Moreover, although the above description mainly discusses embodiments utilizing HTML to express web resources, this is exemplary and non-limiting. In various aspects, any other suitable data language can be implemented (e.g., JavaScript Object Notation (JSON), Extensible Markup Language (XML), HTML abstraction markup language (HAML), and/or so on).

Although not explicitly shown in the figures, various embodiments described herein can exclude the client device 104 and/or the deployed web server 106. In such cases, the browserless testing system 102 can browserless generate and browserlessly transmit HTTP request messages to the web server being tested 108, the browserless testing system 102 can browserless receive HTTP response messages from the web server being tested 108, and the browserless testing system 102 can evaluate body portions of the HTTP response messages to determine whether the web server being tested 108 is functioning as desired.

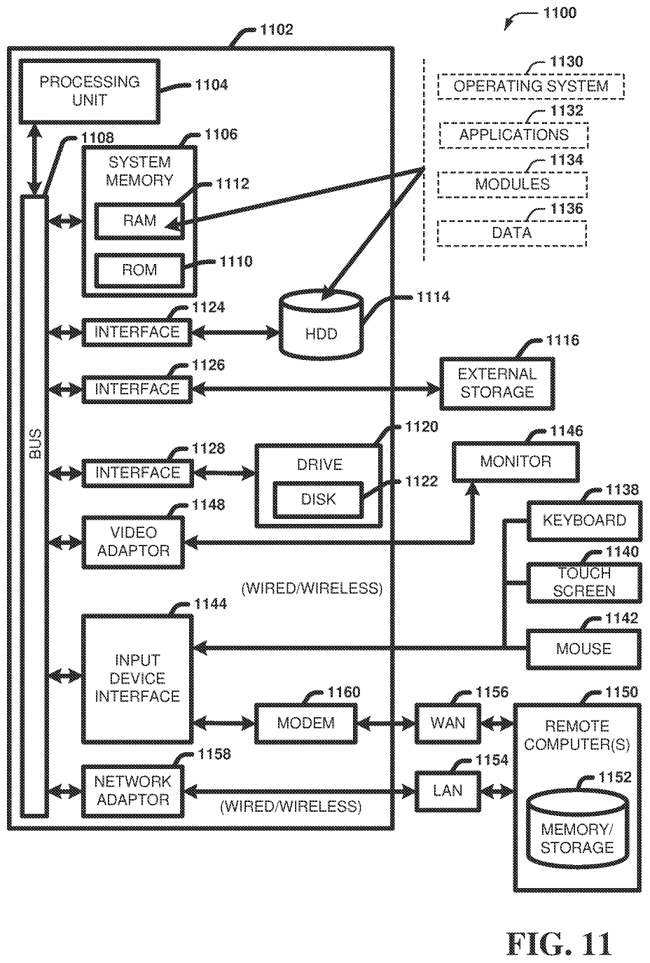

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and a drive 1120, e.g., such as a solid state drive, an optical disk drive, which can read or write from a disk 1122, such as a CD-ROM disc, a DVD, a BD, etc. Alternatively, where a solid state drive is involved, disk 1122 would not be included, unless separate. While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and drive 1120 can be connected to the system bus 1108 by an HDD interface 1124, an external storage interface 1126 and a drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enable with a security module, such as a trusted processing module (TPM). For instance with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above, such as but not limited to a network virtual machine providing one or more aspects of storage or processing of information. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or an ad hoc communication between at least two devices.

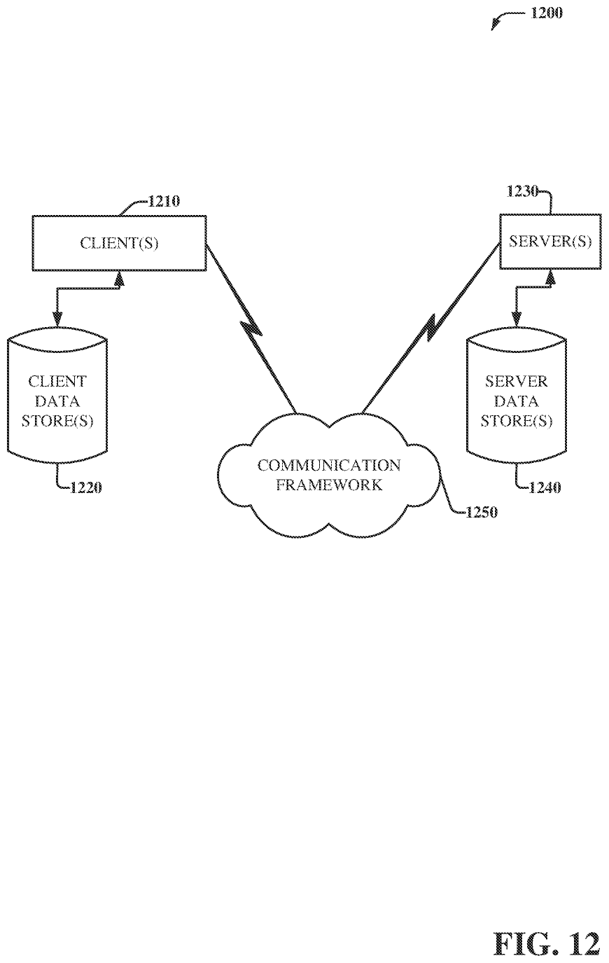

FIG. 12 is a schematic block diagram of a sample computing environment 1200 with which the disclosed subject matter can interact. The sample computing environment 1200 includes one or more client(s) 1210. The client(s) 1210 can be hardware and/or software (e.g., threads, processes, computing devices). The sample computing environment 1200 also includes one or more server(s) 1230. The server(s) 1230 can also be hardware and/or software (e.g., threads, processes, computing devices). The servers 1230 can house threads to perform transformations by employing one or more embodiments as described herein, for example. One possible communication between a client 1210 and a server 1230 can be in the form of a data packet adapted to be transmitted between two or more computer processes. The sample computing environment 1200 includes a communication framework 1250 that can be employed to facilitate communications between the client(s) 1210 and the server(s) 1230. The client(s) 1210 are operably connected to one or more client data store(s) 1220 that can be employed to store information local to the client(s) 1210. Similarly, the server(s) 1230 are operably connected to one or more server data store(s) 1240 that can be employed to store information local to the servers 1230.

Various embodiments described herein may be a system, a method, an apparatus and/or a computer program product at any possible technical detail level of integration. The computer program product can include a computer readable storage medium (or media) having computer readable program instructions thereon for causing a processor to carry out aspects of various embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various embodiments described herein can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of various embodiments described herein.

Aspects of various embodiments are described herein with reference to flowchart illustrations and/or block diagrams of methods, apparatus (systems), and computer program products according to various embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments described herein. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a processor that executes computer-executable instructions stored in a memory, which causes the processor to:
record, via a logging component, a hypertext transfer protocol (HTTP) request message, wherein the HTTP request message is generated by a client device and is transmitted from the client device to a deployed web server;
record, via the logging component, a first HTTP response message, wherein the first HTTP response message is generated by the deployed web server based on the HTTP request message and is transmitted from the deployed web server to the client device;
browserlessly transmit, via a transmitter component, the HTTP request message to a web server undergoing testing, wherein the web server undergoing testing generates a second HTTP response message based on the HTTP request message;
browserlessly receive, via a receiver component, the second HTTP response message from the web server undergoing testing; and
compare, via a validation component, a first message body of the first HTTP response message to a second message body of the second HTTP response message, without rendering the first HTTP response message and without rendering the second HTTP response message.

2. The system of claim 1, wherein the computer-executable instructions are further executable to cause the processor to:
determine, via the validation component and based on the comparison, that the first message body of the first HTTP response message is consistent with the second message body of the second HTTP response message; and
generate, via an alert component, a successful validation alert indicating that the web server undergoing testing successfully responded to the HTTP request message.

3. The system of claim 1, wherein the computer-executable instructions are further executable to cause the processor to:
determine, via the validation component and based on the comparison, that the first message body of the first HTTP response message is not consistent with the second message body of the second HTTP response message; and
generate, via an alert component, an unsuccessful validation alert indicating that the web server undergoing testing unsuccessfully responded to the HTTP request message.

4. The system of claim 1, wherein the computer-executable instructions are further executable to cause the processor to:
determine, via the validation component, that a first header of the first HTTP response message is not consistent with a second header of the second HTTP response message; and
map, via a mapping component, the first header of the first HTTP response message to the second header of the second HTTP response message, thereby yielding a mapping that indicates that a future header of a future HTTP request message is to be replaced with the second header of the second HTTP response message when the future header of the future HTTP request message is equivalent to the first header of the first HTTP response message.

5. The system of claim 1, wherein the computer-executable instructions are further executable to cause the processor to:
modify, via a preprocessing component, the HTTP request message prior to transmitting the HTTP request message to the web server undergoing testing, by replacing a header of the HTTP request message with a prior header of a prior HTTP response message generated by the web server undergoing testing.

6. The system of claim 5, wherein the header of the HTTP request message is a session ID or a tracking token established by the deployed web server, and wherein the prior header of the prior HTTP response message is a session ID or a tracking token established by the web server undergoing testing.

7. A computer-implemented method, comprising:
logging, by a device operatively coupled to a processor, a web request, wherein the web request is transmitted from a client device to a deployed web server;
logging, by the device, a first web response, wherein the first web response is based on the web request and is transmitted from the deployed web server to the client device;
browserlessly transmitting, by the device, the web request to a web server to be tested, wherein the web server to be tested generates a second web response based on the web request;
browserlessly receiving, by the device, the second web response from the web server to be tested; and
comparing, by the device, a first body portion of the first web response to a second body portion of the second web response, without rendering either of the first web response and the second web response.

8. The computer-implemented method of claim 7, further comprising:
determining, by the device and based on the comparing, that the first body portion of the first web response matches the second body portion of the second web response; and
generating, by the device, a successful verification message indicating that the web server to be tested successfully responded to the web request.

9. The computer-implemented method of claim 7, further comprising:
determining, by the device and based on the comparing, that the first body portion of the first web response does not match the second body portion of the second web response; and
generating, by the device, an unsuccessful verification message indicating that the web server to be tested unsuccessfully responded to the web request.

10. The computer-implemented method of claim 7, further comprising:
determining, by the device, that a first header of the first web response does not match a second header of the second web response; and
correlating, by the device, the first header of the first web response to the second header of the second web response, thereby yielding a mapping that indicates that a future header of a future web request is to be replaced with the second header of the second web response when the future header of the future web request is equivalent to the first header of the first web response.

11. The computer-implemented method of claim 7, further comprising:
modifying, by the device, the web request before transmitting the web request to the web server to be tested, by replacing a header of the web request with a prior header of a prior web response generated by the web server to be tested.

12. The computer-implemented method of claim 11, wherein the header of the web request is a session ID or a tracking token established by the deployed web server, and wherein the prior header of the prior web request is a session ID or a tracking token established by the web server to be tested.

13. The computer-implemented method of claim 1, wherein the web request, the first web response, and the second web response implement a version of hypertext transfer protocol.

14. A computer program product for facilitating browserless testing of a web server, the computer program product comprising a computer readable memory having program instructions embodied therewith, the program instructions executable by a processor to cause the processor to:
capture a computing request that is received by a deployed web server;
capture a first computing response that is generated by the deployed web server based on the computing request;
transmit, in absence of a browser, the computing request to a web server being tested, wherein the web server being tested generates a second computing response based on the computing request;
receive, in absence of a browser, the second computing response from the web server being tested; and
compare a first content payload of the first computing response to a second content payload of the second computing response, without rendering any of the first computing response and the second computing response.

15. The computer program product of claim 14, wherein the program instructions are further executable to cause the processor to:
determine, based on the comparison, that the first content payload of the first computing response is consistent with the second content payload of the second computing response; and
generate a notification indicating that the web server being tested successfully responded to the computing request.

16. The computer program product of claim 14, wherein the program instructions are further executable to cause the processor to:
determine, based on the comparison, that the first content payload of the first computing response is inconsistent with the second content payload of the second computing response; and
generate a notification indicating that the web server being tested unsuccessfully responded to the computing request.

17. The computer program product of claim 14, wherein the program instructions are further executable to cause the processor to:
determine that a first header of the first computing response is inconsistent with a second header of the second computing response; and
map the first header of the first computing response to the second header of the second computing response, thereby yielding a mapping that indicates that a future header of a future computing request is to be replaced with the second header of the second computing response if the future header of the future computing request matches the first header of the first computing response.

18. The computer program product of claim 14, wherein the program instructions are further executable to cause the processor to:
modify the computing request before transmitting the computing request to the web server being tested, by replacing a header of the computing request with a prior header of a prior computing response generated by the web server being tested.

19. The computer program product of claim 18, wherein the header of the computing request is a session ID or a tracking token established by the deployed web server, and wherein the prior header of the prior computing request is a session ID or a tracking token established by the web server being tested.

20. The computer program product of claim 1, wherein the computing request, the first computing response, and the second computing response implement a version of hypertext transfer protocol.
